(19) United States
(12) Patent Application Publication
(10) Pub. No.: US 2014/0123175 A1
(43) Pub. Date: May 1, 2014

(54) SESSION BASED ADVERTISING

(71) Applicant: Specific Media LLC, Irvine, CA (US)

(72) Inventors: Steven Michael Cormie, Cambridge (GB); Brian Jentz, Calstone Wellington (GB); Christopher Mark Doe, Playa del Rey, CA (US)

(73) Assignee: Specific Media LLC, Irvine, CA (US)

(21) Appl. No.: 14/061,398

(22) Filed: Oct. 23, 2013

Related U.S. Application Data
(60) Provisional application No. 61/718,321, filed on Oct. 25, 2012.

(51) Int. Cl. H04N 21/81

(52) U.S. Cl. CPC H04N 21/812
USPC 725/34

(57) ABSTRACT

A method, apparatus, and computer program product provide the ability to select and display advertisements. A media content viewing session is commenced. During the session, media content is displayed on a display/media content viewing device (e.g., a television or monitor). A set of advertisements are maintained in an advertisement selection receiver. During the session, the advertisement selection receiver determines, selects, and displays advertisements from the set of advertisements.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/718,321, filed on Oct. 25, 2012, by Steven Michael Cormie, Brian Jentz, and Christopher Mark Doe, entitled “Session Based Advertising,” attorneys' docket number 257.66-US-P1.

This application is related to the following co-pending and commonly-assigned patent applications, which applications are incorporated by reference herein:

U.S. patent application Ser. No. 13/751,884, entitled “System and Method of Augmenting Linear Broadcast Advertising”, by Brian Jentz, Steven Michael Cormie, Christopher Forrest Gordon, David John Terry Evans, and Marcus Christakis Liassides, filed on Jan. 28, 2013, Attorney Docket No. 257.41-US-U1, which application claims the benefit under 35 U.S.C. Section 119(e) of U.S. Provisional Patent Application Ser. No. 61/591,336, entitled “SYSTEM AND METHOD OF AUGMENTING LINEAR BROADCAST ADVERTISING”, by Brian Jentz, Steven Michael Cormie, Christopher Forrest Gordon, David John Terry Evans, and Marcus Christakis Liassides, filed on Jan. 27, 2012, Attorney Docket No. 257.41-US-P1.

U.S. patent application Ser. No. 13/954,665, entitled “VOLUME BAR ADVERTISING”, by Steven Michael Connie and Brian Jentz, filed on Jul. 30, 2013, Attorney Docket No. 257.65-US-U1, which application claims the benefit under 35 U.S.C. Section 119(e) of U.S. Provisional Patent Application Ser. No. 61/677,280, entitled “TELEVISION VOLUME BAR ADVERTISING”, by Steve Cormie and Brian Jentz, filed on Jul. 30, 2012, Attorney Docket No. 257.65-US-P1.

### BACKGROUND OF THE INVENTION

1. Field of the Invention

The present invention relates generally to television advertising, and in particular, to a method, apparatus, and article of manufacture for displaying/delivering a set of advertisements to a user based on a user's TV (television) session. A TV session in this sense means from the moment the user powers up their TV (and/or begins viewing media content) to the moment the TV is powered down (and/or terminates viewing media content).

2. Description of the Related Art

Audio/video media content is consumed by users via a plethora of different hardware platforms in a variety of different formats. Furthermore, such audio/video media content is delivered to such users using a variety of different delivery mechanisms (e.g., broadcast, multicast, unicast, etc.). Regardless of the hardware platform or format, it is often desirable for the content owner, broadcaster, hardware owner, etc. to monetize the delivery and/or consumption of the media content. Advertising is a predominately used mechanism for monetization. Both advertisers and those desiring to monetize the media content delivery/consumption often seek new and creative ways to deliver/display advertising to users/consumers. While existing advertising mechanisms are plentiful, it is always desirable to further improve and find new/unique ways to deliver/display advertising to users as well as to find new ways to increase the advertising revenue and to maximize click-thru of advertisement by consumers.

Television based advertising commonly consists of commercials and advertisement placements during programming. However, with the increased use of the Internet and media viewing devices, televisions and media viewing devices may be connected to the Internet. Such a connection may enable new advertising paradigms and mechanisms for delivering advertisements on connected devices. Prior art techniques that utilize connected devices provide for advertising that is largely based around the electronic program guide (EPG) and content search. An EPG is an interactive program guide that provides users of television, radio, and other media applications with continuously updated menus displaying programming or scheduling information for current and upcoming programming. Advertisements via EPGs and content search engines provide for display ads, that, when selected transport the user/display a microsite (referred to as a click-thru). Click-thru rates in a connected television based context have been over ten times more than a typical click-thru rate for a web-page banner advertisement. Accordingly, it is desirable to find and utilize other methods of advertising in the context of connected media viewing devices.

In view of the above, what is desirable is the capability to deliver/display advertising to users in a new/unique way while taking advantage of network connectivity of media viewing devices.

### SUMMARY OF THE INVENTION

Embodiments of the invention provide a new/unique way to display advertising to users/consumers. In session based advertising, embodiments of the invention determine what and where advertisements are placed within a user session such that a user is engaged throughout a media content viewing session.

### BRIEF DESCRIPTION OF THE DRAWINGS

Referring now to the drawings in which like reference numbers represent corresponding parts throughout:

FIG. 1 is an exemplary hardware and software environment/platform used to implement one or more embodiments of the invention;

FIG. 2 illustrates the interaction between different components of the system/platform of embodiments of the invention;

FIG. 3 illustrates placement location of advertisements within a typical connected television or other media viewing device in accordance with embodiments of the invention;

FIG. 4 illustrates an exemplary advertisement displayed during startup or shutdown in accordance with one or more embodiments of the invention;

FIG. 5 illustrates an advertisement that is displayed within a volume control panel in accordance with one or more embodiments of the invention;

FIG. 6 illustrates an advertisement that is displayed based on the television menus in accordance with one or more embodiments of the invention;

FIG. 7 illustrates an applications portal screen that includes an advertisement and a background screen portion that forms part of a session based advertisement in accordance with one or more embodiments of the invention;

FIG. 8 illustrates an advertisement displayed within an applications marketplace screen that also includes a background that forms part of a session based advertisement in accordance with one or more embodiments of the invention;

FIG. 9 illustrates an exemplary advertisement displayed in an application in accordance with one or more embodiments of the invention;

FIG. 10 illustrates an exemplary microsite in accordance with one or more embodiments of the invention; and

FIG. 11 illustrates the logical flow for displaying/delivering advertisements to a user in accordance with one or more embodiments of the invention

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Based on a media content viewing session, the advertisement/advertisement creative as well as the location of each advertisement is selected to provide a consistent advertising experience.

### Hardware Environment

As used herein, “media content” refers to audio, audio-video, video, images, and/or any other content that can be viewed on a display device. As described above, a variety of different hardware platforms may be utilized to deliver and view media content. Embodiments of the invention are intended to apply to all and/or a subset of such platforms. Several exemplary platforms are described herein but the invention is not limited to such platforms.

It may be useful to note that as used herein, the hardware platform includes several components: (1) the screen/monitor/display on which media content is viewed (referred to as “display device”); (2) the hardware that receives the media content from a source and formats/delivers the content to the display device (referred to as a “media receiver”); and (3) the transmission mechanism/distribution system for the media content. It may also be noted that the functionality performed by each of the components may at times be performed by other components in the hardware platform. In addition, the components may be integrated together. For example, the display device may be integrated into and be part of the media receiver.

Embodiments of the invention may be utilized in the context of television viewing but may also apply to any device that is capable of viewing/displaying media content including cellular devices (e.g., cellular phones), personal digital assistants (PDAs), tablet computers (e.g., the iPad™ tablet), music players (e.g., MP3 players such as iPod™ music players), Set-Top-Boxes (STBs), games consoles, etc. In the context of television viewing, the display device may consist of traditional television display devices (e.g., LED [light emitting diode] televisions, plasma televisions, LCD [liquid crystal display], cathode ray tube [CRT] displays). Such traditional display devices may receive the media content directly from a broadcast source (e.g., via an integrated antenna or via cable, wireless network, etc.) wherein the tuner/receiver is integrated into the display device. Alternatively, the display device may be connected to a tuner/media receiver (e.g., a set top box) that receives the content, decodes the content, etc. for display on the display device. Such a set top box (STB) may receive the content via satellite, cable, broadcast, etc.

In one or more embodiments of the invention, the media content may be viewed on a display device that receives the media content via the Internet or broadband connection. In such an embodiment, the display device may be a computer monitor that receives the content from a computer via a user's broadband connection (e.g., to the Internet). Alternatively, the television itself may be “connected” to the Internet such that it is Internet-enabled. In alternative embodiments, the receiver that delivers content to a display device may consist of hardware/media player specifically directed towards television viewing (e.g., via a broadband connection). Examples of such devices include a Boxee device, an AppleTV™ device, a Google™ set-top box, a Roku™ television device, etc. In yet another embodiment, the display device may consist of a cellular device/phone that receives media content via a cellular network.

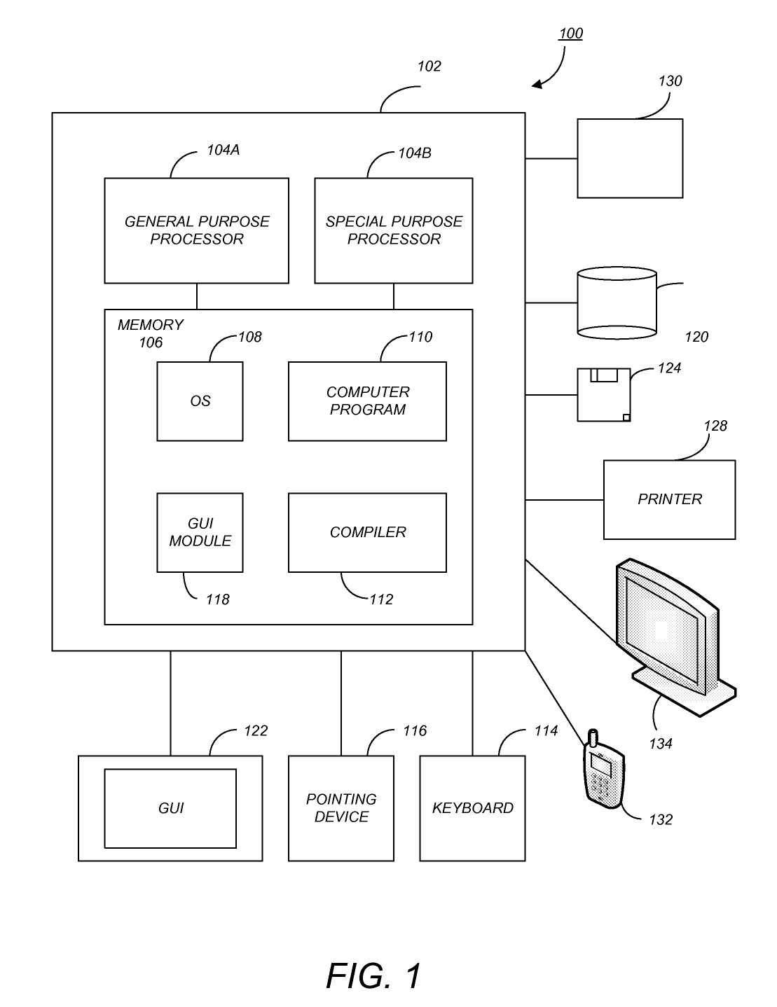

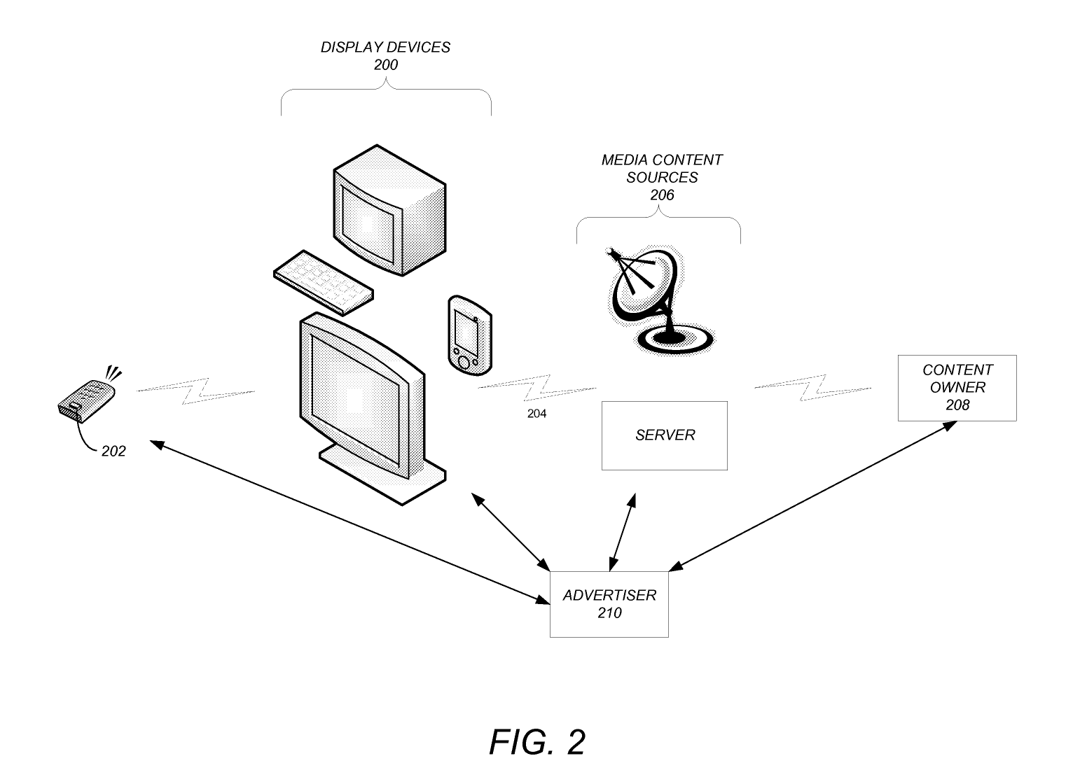

Regardless of the display device utilized, the common component across all such display devices is each display device is configured to display/playback/deliver media content to a user. While embodiments of the invention may be utilized in a variety of contexts and hardware platforms, as described above, exemplary platforms are illustrated in FIGS. 1 and 2.

FIG. 1 is an exemplary hardware and software environment/platform 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128.

In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television 134, television set top box, or other internet enabled device 134 executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device (e.g., device 134) for presentation or further processing or action. In one embodiment, the display 122/134 comprises a liquid crystal display (LCD) having a plurality of separately addressable liquid crystals. Alternatively, the display 122/134 may comprise a light emitting diode (LED) display having clusters of red, green and blue diodes driven together to form full-color pixels. Each liquid crystal or pixel of the display 122/134 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122/134 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs). Alternatively, display 122/134 may consist of a television display device that has a built in tuner/receiver or is connected to a set-top-box configured to receive media content.

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and/or providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to implement and/or use the present invention or to load the program of instructions into a memory, thus creating a special purpose data structure causing the computer 102 to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

FIG. 2 illustrates the interaction between different components of a system/platform of embodiments of the invention. As illustrated, display devices 200 are used to display the media content. Such display devices 200 include cellular devices, television monitors, computers, computer monitors, etc.

The display devices 200 receive the media content across network 204 from media content sources 206. Network 204 may consist of a cellular network, satellite network, broadband network, or any type of network capable of transmitting media content. Such media content sources 206 may include broadcasters (e.g., one of the broadcast networks), media content providers (e.g., a cable provider such as Comcast™, satellite provider such as DirecTV™, etc.), computers (e.g., a server or other computer connected to display devices 200 and/or configured to receive content and deliver such content to display devices 200). Further, such computers may be configured to utilize a media player (e.g., Windows™ Media Player™, Quicktime™, etc.) to display media content on a display device 200.

Media content sources 206 may receive such content from content owners 208 (e.g., movie/television studios, private individuals, record companies, etc.).

Advertisements that are displayed in accordance with embodiments of the invention are received from advertiser 210. As used herein, advertisements may be static images (display advertisements) or video advertisements or a combination of both. Advertiser 210 may communicate/transmit advertisements to any of the entities involved (e.g., content owner 208, media content sources 206, and/or display devices 200). As used herein, an advertiser may be an actual advertiser, an advertising network (e.g., Specific Media™), an advertising exchange, an advertising server, or any system or combination of systems that delivers an advertising creative to another system or device. In yet another embodiment, remote control 202 may also have display capabilities, and advertisements may be displayed on remote control 202 as well.

When advertiser 210 communicates with media content sources 206, the advertiser 210 may negotiate with media content sources 206 to determine the cost, length of time, etc. for placement of an advertisement. Thereafter, the advertisement may be inserted by media content sources 206 into the media content. Alternatively, a placeholder may be specified in the media content with the advertisement delivered to display devices 200 for delivery to the user/consumer. Consequently, advertisements may be integrated into the media content or may be delivered separately from such media content. Further, in different embodiments, each component (e.g., the content owner 208, media content sources 206, and/or display devices 200) may have the ability to control the advertisement that is displayed/delivered to a user/consumer.

### Advertisement Placement Locations

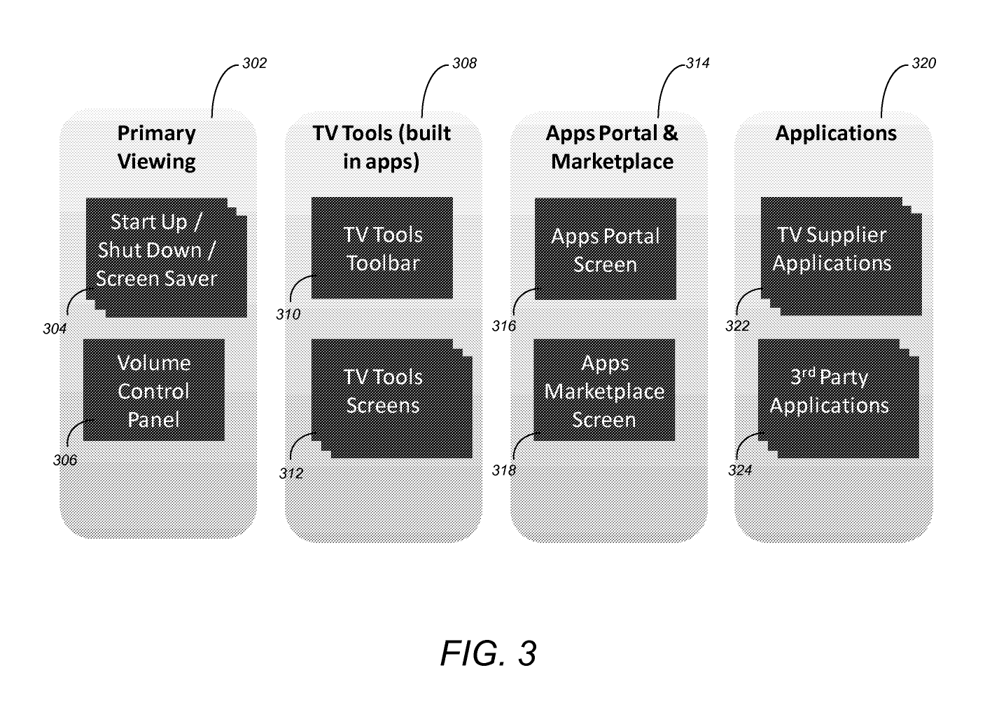

Advertisements utilized herein can be placed in a variety of locations within a viewing/listening device. FIG. 3 illustrates placement location of advertisements within a typical connected television or other media viewing device in accordance with embodiments of the invention.

As part of the primary viewing area 302, an advertisement may be displayed as part of/during start up/shut down 304 or as part of a screen saver 304 of a media viewing device. Further, an advertisement may be displayed in a volume control panel 306 as described in co-pending application Ser. No. 13/954,665 cross referenced above.

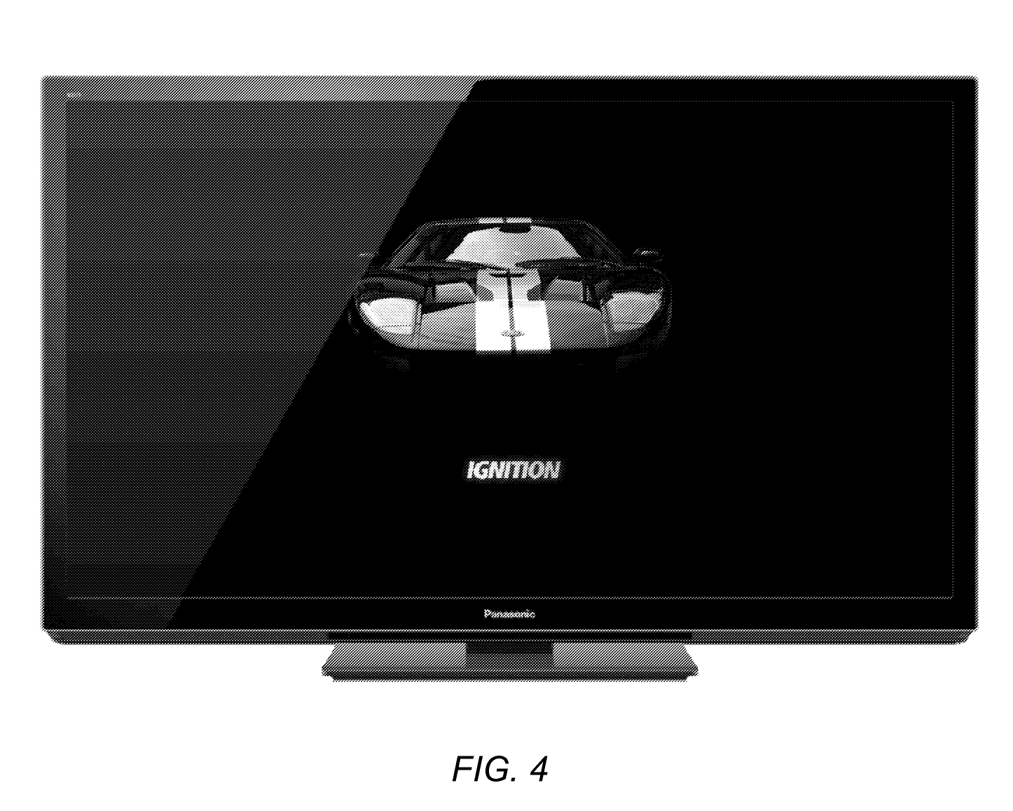

FIG. 4 illustrates an exemplary advertisement displayed during startup in accordance with one or more embodiments of the invention. As illustrated, a Ford™ automobile is displayed when the television is powered on. One may note that the very first time a television is powered on, no advertisement may be loaded/cached into the display device. Accordingly, a random ad may be retrieved and displayed. Subsequent to the very first boot/power on, advertisements may already exist in cache and may be delivered/displayed to a user based on an advertising session as described below. In this regard, during a current session, a future/next session may be setup by caching ad images.

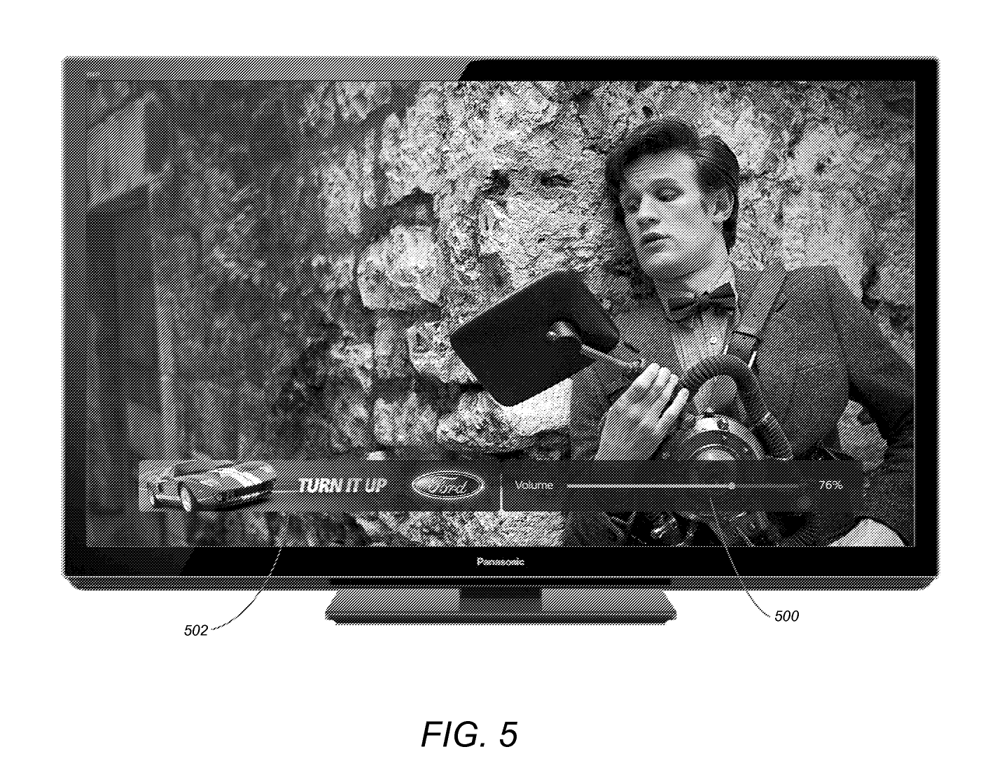

FIG. 5 illustrates an advertisement 502 that is displayed within a volume control panel 500 (e.g., when a user presses the volume up/down on a remote control or display device, a volume bar 500 appears on the display device along with/that incorporates an advertisement 502).

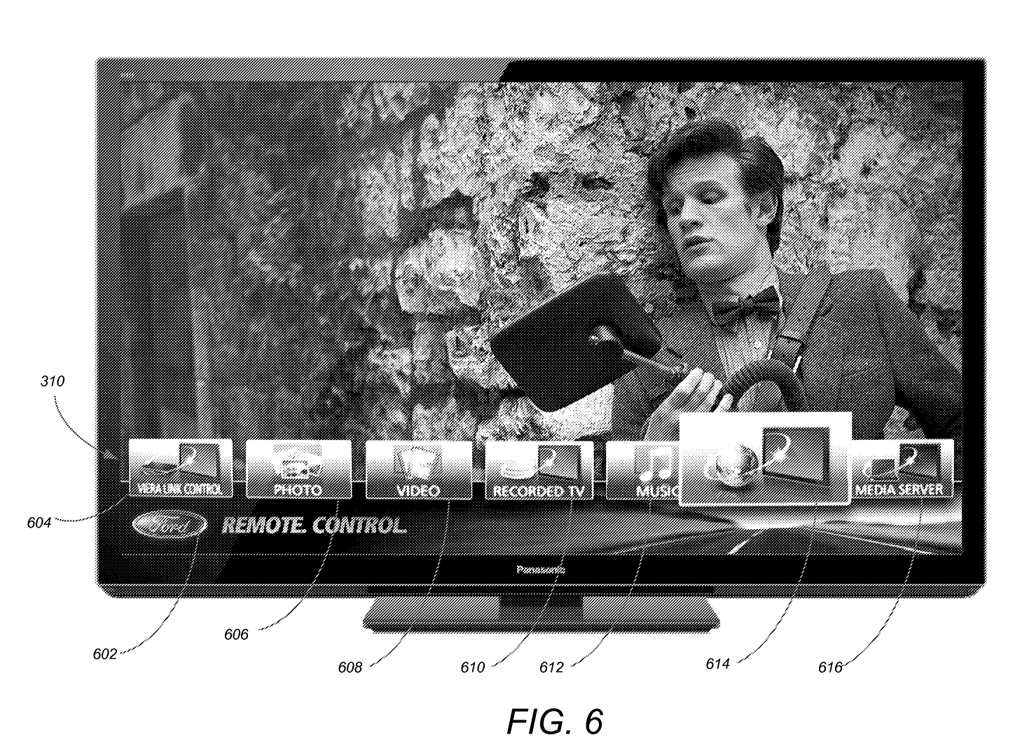

Returning to FIG. 3, television menus 308 including built in applications or other television specific features may also provide a location for advertisements such as in a television tools toolbar 310 and or television tools screens 312. FIG. 6 illustrates an advertisement 602 that is displayed based on the television tools toolbar 310. As illustrated, various icons representing tools that can be activated by the user are displayed in toolbar 310. In FIG. 6, there is a viera link control tool 604, a photo tool 606, a video tool 608, a recorded tv tool 610, a music tool 612, an internet browsing tool 614 (currently selected by the user), and a media server tool 616. When the toolbar 310 is displayed, the various tools 604-614 are displayed along with advertisement 602 displayed below/adjacent/nearby toolbar 310.

An applications portal and marketplace 314 (e.g., provided by a gaming device such as a Microsoft™ Xbox 360™, Nintendo™ Wii™, Playstation 3™, etc.) may also provide a location for advertisements. Such advertisements may be placed within an applications portal screen 316 or in an applications marketplace screen 318.

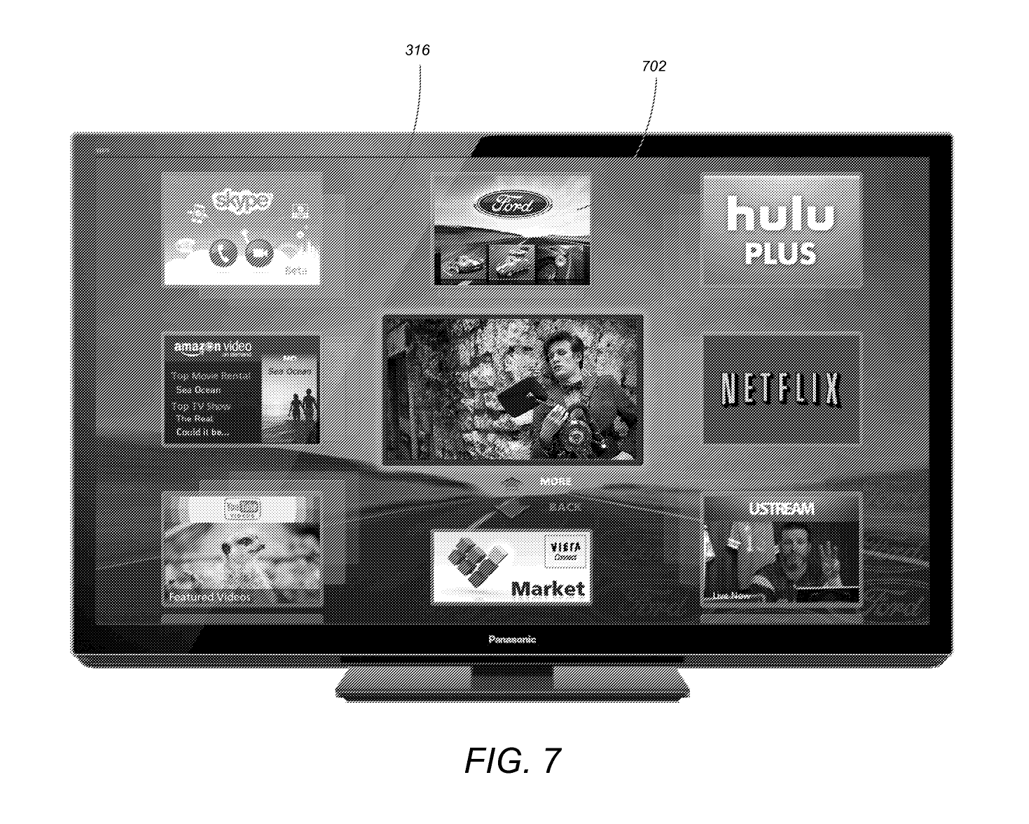

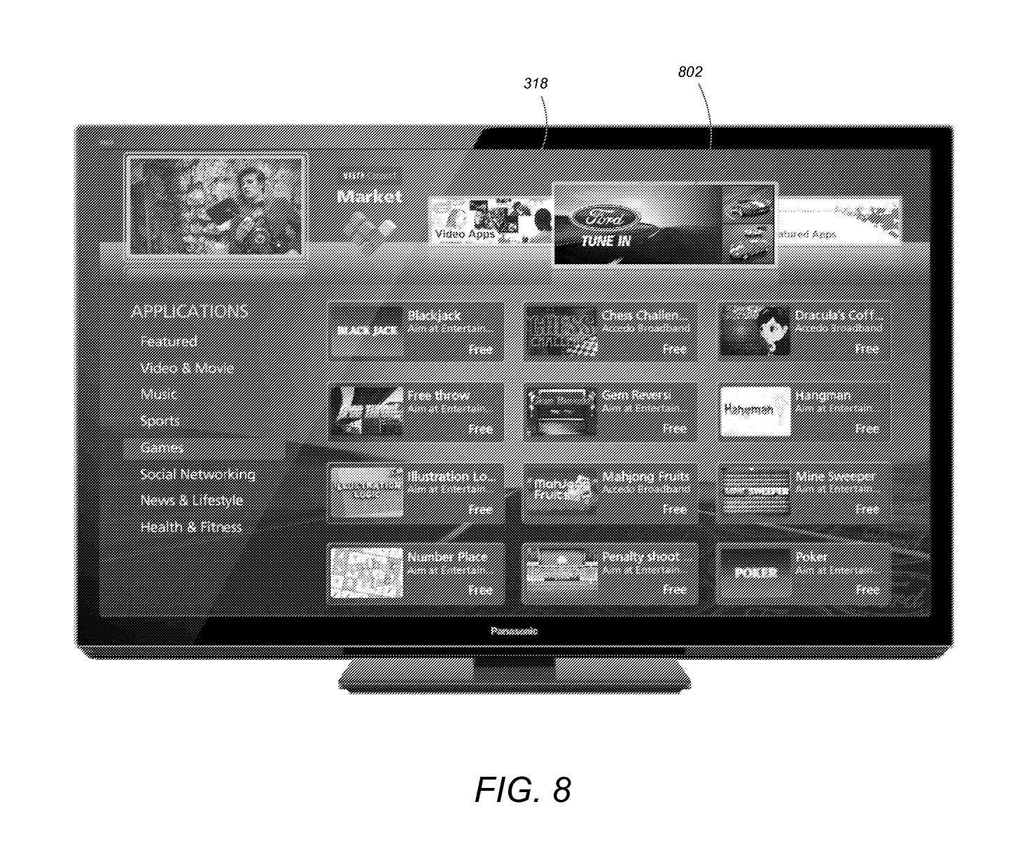

Such a portal 316 or marketplace 318 is usually an application that allows users to download/shop for other applications, media content, etc. FIG. 7 illustrates an applications portal screen 316 (containing various icons for the applications available within portal screen 316) that includes an advertisement 702. Similarly, FIG. 8 illustrates an advertisement 802 displayed within an applications marketplace screen 318. In this regard, when a user navigates to an application marketplace 318 (to purchase or retrieve various applications/products/services), the advertisement 802 may be displayed.

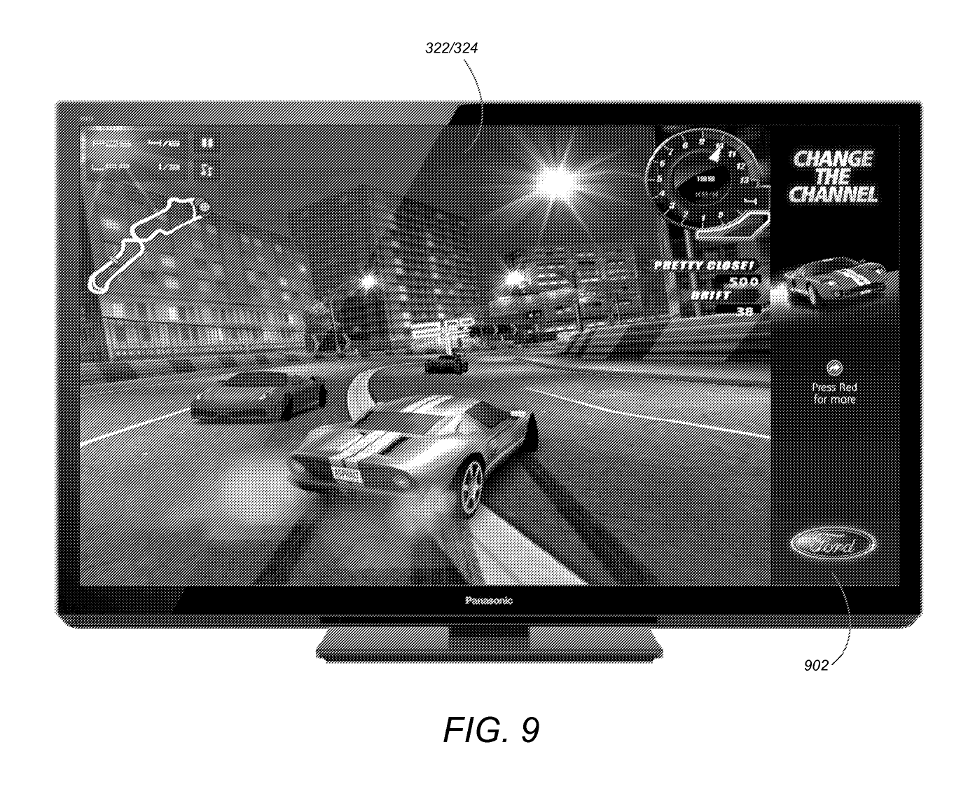

Returning again to FIG. 3, an application 320 may also provide the ability to display advertisements (e.g., in a television supplier application 322 and/or a third party application 324). FIG. 9 illustrates an exemplary advertisement 902 displayed in an application 322/324 (e.g., the illustrated application 322/324 consists of a race driving simulation application/game).

In any of the above described advertisement placement locations, the advertisement may be a banner advertisement, an icon, an interactive widget, a video advertisement, etc. There are various options that may be configurable for any of the advertisements. Options for the advertisements may include any (or none) of the following:
the location of the advertisement;
the duration of the display of the advertisement
the size of the advertisement;
the frequency for modification of the advertisement;
etc.

Embodiments of the invention may further provide the ability for a user or other administrator to modify such options.

Further, in one or more embodiments, a determination may be made regarding where the advertisement would be the most visible and/or most visible yet not interfere with the user's viewing/interaction with the media content. For example, a determination may be made that the advertisement consists of dark colors.

Such coloring may be compared to images of the media content that are displayed to determine the best location for such content. For example, a dark advertisement may be the most visible in the upper left corner of the media content and such a determination could result in the placement of the advertisement at such a location. Alternatively, such a determination may result in a finding that placement in the upper left corner would interfere with the user's viewing of the media content and thereby select an alternative location. In yet another embodiment, the coloring, transparency, or other attribute of the advertisement that is displayed may be dynamically changed based on a variety of factors. For example, if multiple advertisements for the same product are available in different colors, an advertisement with a particular coloring scheme may be selected based on the media content over which the advertisement is being displayed (or based on other factors provided by an advertisement selection methodology).

The size of the advertisement may also be adjustable/modifiable based on the context of the advertisement. For example, an advertisement may be scaled based on the volume control panel 306, an application displayed in a marketplace 318, or based on an application 320. For example, the advertisement may be adjusted to be the same size as the volume bar, slightly smaller, slightly larger, a small/medium/large icon, etc. In one or more embodiments, the size of the advertisement itself may vary/change. For example, the advertisement may progressively decrease in size or fade until it is no longer displayed (thereby interfering with the viewing of the media content in a progressively decreasing manner). Further, the size of the advertisement may be established so as to not obscure or be burdensome/over-intrusive to the user's viewing experience. In this regard, as a session-based advertising concept is utilized, the sizes/duration of the advertisements may be balanced to provide an aesthetically and visually appealing experience to the user.

As described above, the advertisement that is displayed may be periodically modified. The frequency for how often the advertisement changes may also be defined. For example, the advertisement that is selected may only be presented to the user at a defined interval (e.g., every time, every other time, every third time, etc. that a placement location 302, 308, 314, and 320 is displayed). Alternatively, an advertisement may only be displayed at the defined intervals and interspersed with other advertisements or no advertisements. Rather than specifying an interval, a period of time may also be specified/defined (e.g., one advertisement every ten minutes).

As described above, a variety of different options and configurations may be available for both the frequency, display time, location, selection, etc. of an advertisement that is displayed. Different options may also be available beyond those described herein.

### Microsites

In addition to the above, the advertisement may have a “click-through” action where the user presses another button on the remote control (or touch screen device), while the advertisement is still displayed, and the user is taken to a “microsite” where more information about the product can be seen, videos can be played, product can be purchased, etc. Thus, the activation of the secondary remote control button, serves to deliver the user to a website or other location where further promotional activities relating to the advertised product/service may be available. Such an activation of a secondary (or another button) may also serve to deliver the user to a micro-site where the properties/options for the display of the advertisements may be adjusted/modified.

Each micro-site may be developed specifically for a television experience and an existing web-site may not be reused. In this regard, a microsite may be used to provide detailed information about a product, service, or brand, create a call-to-action (e.g., sign for a newsletter, enter sweepstakes, etc.), and/or to sell items. Thus, a microsite may make full use of the power of the platform for a television or media viewing device.

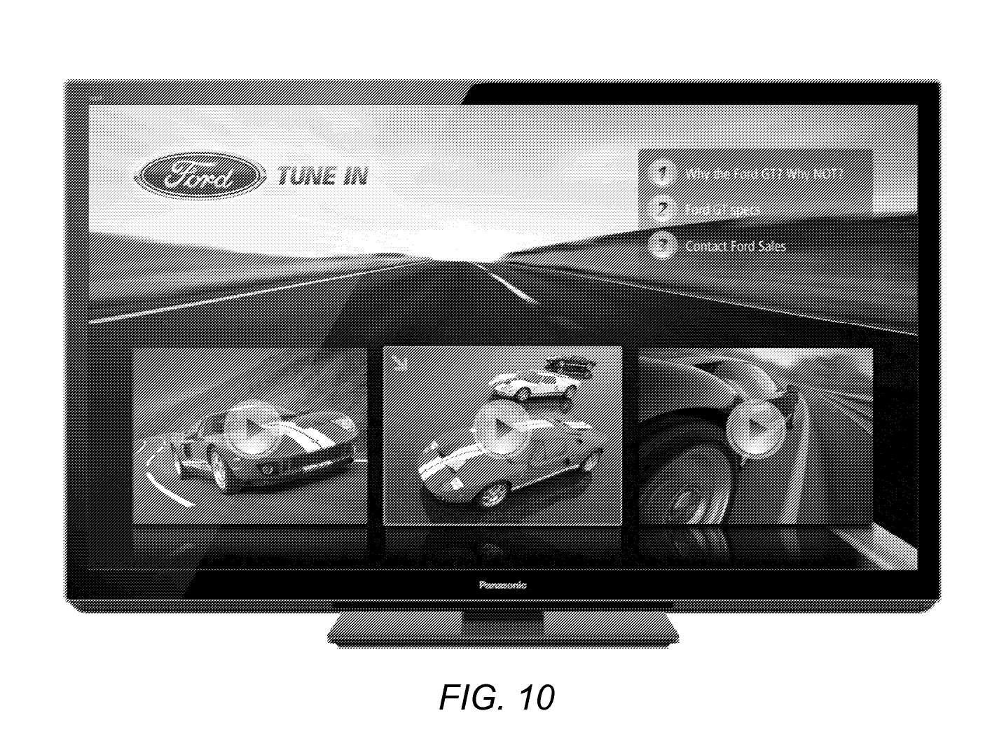

FIG. 10 illustrates an exemplary microsite in accordance with one or more embodiments of the invention. Such a microsite may be displayed upon selection (by a user) of one of the various Ford™ advertisements illustrated in FIGS. 4-9. As illustrated, the microsite is for Ford™ and prompts the user to select various remote control numeric buttons to retrieve/view further information. The user may select the “1” button to view a video that answers the question “Why the Ford GT? Why NOT?” Alternatively, the user can retrieve Ford GT specs by selecting “2” or may contact Ford Sales by selecting “3”. Alternatively (or in addition), the user can highlight a particular image (of the three images displayed at the bottom of the screen) and play a video (e.g., of the Ford GT).

In one or more embodiments, the activation of a link transporting a user to a micro-site may be tracked. Further yet, different statistics may be tracked based on the number of advertisements or percentage of an advertisement that has been viewed/consumed by a user. For example, statistics regarding whether 0%, 25%, 50%, 75%, and/or 100% of an advertisement has been viewed may be maintained. In addition, different advertisements may be defined depending on the percentage of an advertisement that has been viewed/consumed. For example, an array of links to websites may be utilized if 25% of an advertisement is consumed, and a different array of links may be utilized if 50% of an advertisement has been consumed. Such a link may be content consumption tracking URLs (uniform resource locators). In addition, embodiments of the invention may provide the ability for users to opt out of advertising tracking (e.g., via privacy settings).

### Session Based Advertising

In session based advertising, the concept is to determine what and where advertisements should be placed within a user session. The concept is to balance advertising revenue with consumer tolerance. In this regard, advertisements can be placed in a variety of locations (as described above) within a typical television/media content viewing experience. For each viewing “session” (i.e., from when the user turns on a television/media device or begins viewing media content to when the user shuts down or terminates the view of the media content), all advertisement positions are filled with advertisements from one advertiser or from one group of advertisers. In an alternative embodiment, a limited number of quality/specific advertisers by category may be selected (e.g., two-three advertising partners per category [e.g., automotive, banking, etc.]), and an advertisement from any advertising partner within a category may be selected during a user “session.”

The ad creative, message, size, etc. may be tailored to the user interface location. Advertisement pricing may be based around the number of impressions, click-thrus, etc. per “session”. Ad creatives are built around the “session” paradigm to engage the user throughout the media content viewing session. In one or more embodiments, the advertiser may be rotated on a media content viewing “session” basis.

The use of session based advertising is based on the hypothesis that the whole is greater than the sum of its parts in the media content advertising paradigm. In other words, given the number, duration, and nature of available advertisement locations, a session based advertisement strategy may have a higher impact. The media content viewing (e.g., television) platform is ideally suited for relatively passive branding and product awareness/discovery oriented advertising—tying the advertisement slots together provides an improved ability to deliver this type of advertising.

Session based advertising may also reduce feelings of intrusiveness and spam. For example, advertisements may be allowed to be more subtle and less intrusive as each individual advertisement location does not itself need to convey the entire message. Accordingly, feelings of advertisement “spam” or “noise” are reduced because there is a perception of less/fewer advertisements that may occupy less screen real estate (compared to that of a full advertisement). For example, rather than displaying an advertisement that consumes a large portion of a display, an advertisement may only be a small icon or text in a corner. However, when multiple advertisements for the same/same group of advertisers are displayed over the course of a viewing session, the impact of all of the combined ads is greater than a single large advertisement that may annoy or appear as spam to the user.

In addition, with session based advertisements, a user is provided with the ability to investigate an advertised product/service on his/her own time. Transitory advertisements may be utilized wherein the user is given multiple opportunities to interact with an advertisement (when they are ready/willing). Multiple advertisement touch points enable advertisers to “tell a story”. Such “story” based advertisement sessions can have a higher impact than a single standard advertisement. In addition, multiple touch points aid in the effectiveness of the advertisement(s).

Further advantages to session based advertising include the fact that advertisers may be willing to pay more for such an opportunity. Advertiser interest may be generated as session based advertising is a new, unique, and innovative advertisement type. In this regard, while it may be difficult to sell some of the advertisement placement locations individually, selling the advertisements as part of a session serves to improve fill rates. Further, session based advertising is easier to manage as advertising may be relatively simple compared to that of multiple advertisements for multiple advertisers for multiple product/services in a single session. Such an approach enables the ability to conduct positive case studies with/without advertising partners/advertisers.

To enable the display of the advertisements during a “session”, embodiments of the invention may store one or more advertisements in cache or memory that is directly accessible by the display device. For example, an internet enabled television may have memory or other storage where a banner advertisement is stored and retrieved from such that the advertisement is readily available. Such advertisements may be delivered synchronously with or asynchronously from the media content. Such advertisement storage may be necessary/useful, for example, in order to display an advertisement when a display device is powered on. Further, the storage of an advertisement in such a manner allows for the display of an advertisement without significant delay time. An “expiration check” may also be conducted to determine whether a stored memory cache ad is still valid (or has exceeded a defined time period). Once the time period for an ad has expired, such an ad may no longer be displayed to the user. For example, if a user has not turned their television on for an extended/significant period of time, the ad campaign that was cached for the next session may have expired. Thus, any ad in such an ad campaign would not be delivered/displayed to the user. The expiration check ensures that such an ad/ad campaign is not delivered/displayed.

In one or more embodiments, the advertisement is accompanied by/transmitted with metadata that identifies the options/properties/type (e.g., volume bar based advertisement) of advertisement. Such an advertisement and/or metadata may be transmitted within the blanking interval or ancillary data space of a broadcast (analog or digital) signal. Such metadata may provide the ability to determine the storage, placement, and use of the advertisement desired by the media content source, media content owner, and/or advertiser.

In addition to the above, session based advertising may be utilized to provide advertisements in the context of traditional linear advertising with linear broadcast channels, in the context of overlaying advertisements over the top of traditional linear advertising, and in the context of video-on-demand (VOD) (e.g., pre-roll, mid-roll advertisements).

An exemplary advertising session may focus around a specific car manufacturer (e.g., Ford™). In an advertisement session, the user may start up the television and see the car manufacturer start-up advertisement. The user then turns to a linear channel (e.g., “Myspace One” which is a 24/7 linear broadcast channel owned and operated by the assignee of the present application). The user turns up the volume and sees a car manufacturer advertisement in the volume bar. The program on the linear channel then goes to commercial break and a linear (video) advertisement for the car manufacturer may be dynamically inserted for the user to watch.

Accordingly, the session-based concept can be applied to linear broadcast channels where:

(1) Linear advertisements are dynamically inserted into a linear broadcast stream. Note that such insertion could be performed for channels which are owned and operated by an entity providing session-based advertising or by “affiliates” (e.g., local channels that typically include blank spaces to fill in with advertisements); and

(2) Linear advertisements are dynamically replaced in a linear broadcast stream (this would be dependent upon having the appropriate commercial agreements in place with the content owner and advertiser).

As used herein the term “overlay advertisements” refers to advertisements as set forth in co-pending patent application Ser. No. 13/751,884 which is incorporated by reference herein. Similarly, VOD advertising refers to typical pre-roll or mid-rolls (advertising served before and/or during a video stream) received by a user when watching an on-demand video (e.g., a movie from a content provider such as Netflix™).

### Logical Flow

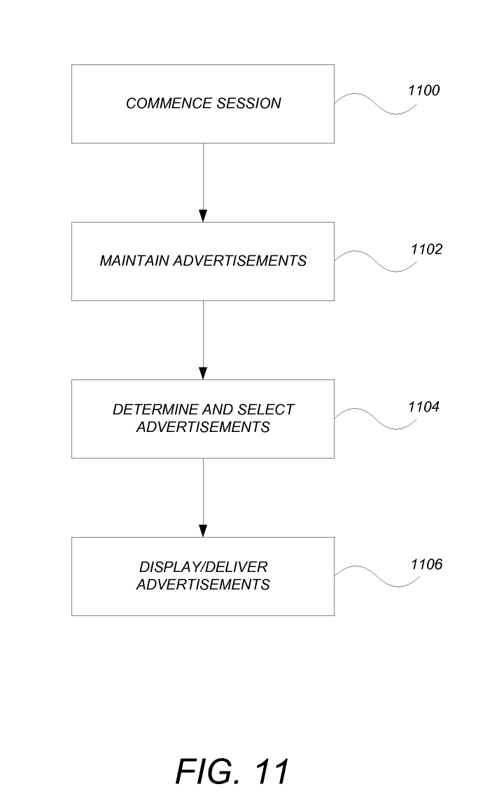

FIG. 11 illustrates the logical flow for displaying/delivering advertisements to a user in accordance with one or more embodiments of the invention. Alternative logic may also be utilized in accordance with one or more embodiments of the invention.

At step 1100, a media content viewing session is commenced. During the media content viewing session, media content is displayed on a display device/media content viewing device (e.g., a television, monitor, etc.). The media content viewing session may commence based upon a media content viewing device being powered on, and may terminate when the media content viewing device is powered off. Alternatively, the media content viewing session may commence based upon the user beginning to view media content and may terminate when the user terminates viewing the media content. In yet another embodiment, any combination of power on/off and/or commencing/terminating viewing (and/or any other events) may trigger the commencement/termination of the media content viewing session.

At step 1102, a set of advertisements are maintained in an advertisement selection receiver. Such an advertisements selection receiver may be a hardware receiver (e.g., a set top box or computer) or may be an application executing within such receiver. Thus, an advertisement selection receiver may be within the media content viewing device itself or may be performed by a computer/set-top box/other device that is communicatively coupled to the media content viewing device. The set of advertisements may consist of two or more advertisements that are configured to be displayed at different locations and different times within the display/media content viewing device. Further, the set of advertisements may consist of two or more advertisements that fulfill all advertisement positions on the media content viewing device during the media content viewing session. In addition, all advertisements in the set of advertisements may be from a single advertiser that is rotated on a media content viewing session basis.

The advertisements in the set of advertisements and the size of the advertisements in the set of advertisements may also be tailored to a user interface location of the media content viewing device. The advertisement selection receiver may at any time request that the advertiser, advertising network or other system or service for delivering advertisements replace the set of advertisements with those for a different advertiser.

The advertisement selection receiver may cache any or all of these advertisements or request them to be delivered in real-time when an advertisement is required to be displayed. Such a cache of advertisements may be established for the next/future sessions (e.g., during a current session) (e.g., in order to cache ads/ad images for when no network connection is available such as during the media viewing device start-up/power on). Such a cache of advertisements may expire (e.g., to ensure that advertising sessions/campaigns that are past a certain date and/or time are not utilized).

During the media content viewing session, the advertisement selection receiver performs steps 1104 and 1106.

At step 1104, the advertisement selection receiver determines and selects one or more advertisements from the set of advertisements. The advertisement selection receiver may select these advertisements from cache or request them to be delivered in real-time when an advertisement is required to be displayed.

At step 1106, the advertisements selection receiver displays/delivers the selected one or more advertisements on the media content viewing device/to the user.

It may be noted that the one or more advertisements that are selected and displayed may be related such that each advertisement is part of a whole advertising structure that is conveyed during the media content viewing session. In addition, the advertisement pricing for the set of advertisements may be established/defined on a media content viewing session basis. Further, counts may be maintained with respect to the display of the ads (e.g., the number of times a boot advertisement is shown during power on, and/or determining how many times during a session an advertisement is shown). In addition, while in a session, a session ID (identification) may be utilized and attached to exchanges (e.g., via JSON—Java™ Script Object Notation) in order to ensure the appropriate advertisements are displayed during a session as well as to track information and ads during a session.

As part of the display/delivery of advertisements, a log/history/reporting of the advertisement delivery may be stored/recorded/delivered to the appropriate entity. The delivery/display of an advertisement is referred to herein as an “ad impression”. In this regard, an ad impression serves as a measure of the number of times an advertisement is displayed, whether it is clicked on or not. Each time an advertisement is displayed, it is counted as one impression. Counting impressions is the method by which web advertising is often accounted and paid for (and the cost is quoted in cost per thousand impressions [CPM]). A problem may arise if a network connection does not exist when an advertisement is displayed (e.g., a boot advertisement). Embodiments of the invention provide for deferred impressions such that ad impressions that cannot be delivered are deferred until a network connection is present/available.

### CONCLUSION

This concludes the description of the preferred embodiment of the invention.

The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for displaying advertisements, comprising:
(a) commencing a media content viewing session, wherein during the media content viewing session, media content is displayed on a media content viewing device;
(b) maintaining a set of advertisements in an advertisement selection receiver;
(c) during the media content viewing session, the advertisement selection receiver:
(1) determining and selecting one or more advertisements from the set of advertisements; and
(2) displaying the selected one or more advertisements on the media content viewing device.

2. The method of claim 1, wherein:
the media content viewing session commences based upon the media content viewing device being powered on; and
the media content viewing session terminates when the media content viewing device is powered off.

3. The method of claim 1, wherein:
the media content viewing session commences based upon the user beginning to view media content; and
the media content viewing session terminates when the user terminates viewing media content.

4. The method of claim 1, wherein the set of advertisements comprises two or more advertisements configured to be displayed at different locations and different times within the media content viewing device.

5. The method of claim 1, wherein the set of advertisements comprises two or more advertisements that fulfill all advertisement positions on the media content viewing device during the media content viewing session.

6. The method of claim 1, wherein all advertisements in the set of advertisements are from a single advertiser.

7. The method of claim 6, wherein the single advertiser is rotated on a media content viewing session basis.

8. The method of claim 1, wherein the advertisements in the set of advertisements and the size of the advertisements in the set of advertisements are tailored to a user interface location of the media content viewing device.

9. The method of claim 1, wherein advertisement pricing for the set of advertisements are on a media content viewing session basis.

10. The method of claim 1, wherein the one or more advertisements that are selected and displayed are related such that each advertisement is part of a whole advertising structure that is conveyed during the media content viewing session.

11. The method of claim 1, further comprising processing a future media content viewing session during the media content viewing session that has commenced by caching one or more advertisements that are part of the future media content viewing session.

12. The method of claim 11, wherein:
the caching has an expiration;
the one or more advertisements that cached are not selected and displayed if beyond the expiration.

13. The method of claim 1, further comprising deferring a delivery of an ad impression until a network connection is available.

14. A system for displaying advertisements, comprising:
an advertisement selection receiver communicatively coupled to a media content viewing device, wherein the advertisement selection receiver is configured to:
(a) commence a media content viewing session, wherein during the media content viewing session, media content is displayed on the media content viewing device;
(b) maintain a set of advertisements;
(c) determine and select, during a media content viewing session, one or more advertisements from the set of advertisements; and
(d) display, during the media content viewing session, the selected one or more advertisements on the media content viewing device.

15. The system of claim 14, wherein:
the media content viewing session commences based upon the media content viewing device being powered on; and
the media content viewing session terminates when the media content viewing device is powered off.

16. The system of claim 14, wherein:
the media content viewing session commences based upon the user beginning to view media content; and
the media content viewing session terminates when the user terminates viewing media content.

17. The system of claim 14, wherein the set of advertisements comprises two or more advertisements configured to be displayed at different locations and different times within the media content viewing device.

18. The system of claim 14, wherein the set of advertisements comprises two or more advertisements that fulfill all advertisement positions on the media content viewing device during the media content viewing session.

19. The system of claim 14, wherein all advertisements in the set of advertisements are from a single advertiser.

20. The system of claim 19, wherein the single advertiser is rotated on a media content viewing session basis.

21. The system of claim 14, wherein the advertisements in the set of advertisements and the size of the advertisements in the set of advertisements are tailored to a user interface location of the media content viewing device.

22. The system of claim 14, wherein advertisement pricing for the set of advertisements are on a media content viewing session basis.

23. The system of claim 14, wherein the one or more advertisements that are selected and displayed are related such that each advertisement is part of a whole advertising structure that is conveyed during the media content viewing session.

24. The system of claim 14, wherein the advertisement selection receiver is further configured to process a future media content viewing session during the media content viewing session that has commenced by caching one or more advertisements that are part of the future media content viewing session.

25. The system of claim 24, wherein:
the caching has an expiration;
the one or more advertisements that cached are not selected and displayed if beyond the expiration.

26. The system of claim 14, wherein the advertisement selection receiver defers a delivery of an ad impression until a network connection is available.
